(19) United States
(12) Patent Application Publication
(10) Pub. No.: US 2021/0268440 A1
(43) Pub. Date: Sep. 2, 2021

(54) DIRECT WATER PURIFIER

(71) Applicant: WOONGJIN COWAY Co., Ltd., Gongju-si (KR)

(72) Inventors: Hyoung-Min MOON, Seoul (KR); Chul-Ho KIM, Seoul (KR); Hyun-Seok MOON, Seoul (KR); Hyun-Soo SHIN, Seoul (KR); Byung-Sun MO, Seoul (KR); Byoung-Phil LEE, Seoul (KR); Min-Chul YONG, Seoul (KR); Jae-Man KIM, Seoul (KR); Sung-Kon CHO, Seoul (KR)

(73) Assignee: WOONGJIN COWAY Co., Ltd., Gongju-si (KR)

(21) Appl. No.: 17/259,028

(22) PCT Filed: Jul. 10, 2019
(86) PCT No.: PCT/KR2019/008462

§ 371 Date: Jan. 8, 2021

(30) Foreign Application Priority Data
Jul. 11, 2018 (KR) 10-2018-0080396

(51) Int. Cl. B01D 61/08; B01D 61/02; B01D 61/10; B01D 61/04; B01D 65/02

(52) U.S. Cl. CPC B01D 61/08; B01D 61/025; B01D 61/10; B01D 61/04; B01D 65/02; B01D 2311/04; B01D 2321/12; B01D 2311/2649; B01D 2313/18; B01D 2313/083; B01D 2313/243; B01D 2321/04; B01D 2311/06

(57) ABSTRACT

A direct water purifier comprises: a first filter for filtering water flowing in through a first flow path; a second filter receiving, through a second flow path, and filtering the water filtered by the first filter; a first valve, provided on the second flow path; a pump, provided on the second flow path, for supplying, to the second filter, water at a water pressure equal to or greater than a preset water pressure; a third filter receiving, through a third flow path, and filtering the water filtered by the second filter; a second valve, provided on the third flow path, for decreasing a pressure in the flow path; a third valve, provided at a rear end of the second valve, for preventing a backflow of the water; and a heating unit receiving the water filtered by the third filter and heating the water to a preset temperature.

### TECHNICAL FIELD

The present invention relates to a direct water purifier.

### BACKGROUND ART

A water purifier is a device for providing purified water by purifying raw water supplied from an external source, and a direct water purifier without a storage tank has been widely used in accordance with increasing user demand for fresher water and the trend of miniaturization of a product. Also, in addition to providing purified water, a water purifier generating cold water and hot water using purified water and providing the water has also been widely used.

However, in the case of operating an instantaneous water heater to instantly provide hot water in a direct manner, as a flow rate is adjusted to heat the purified water to a desired temperature, the pressure in a flow path of the water purifier may increase excessively, and accordingly, an extraction flow rate may be unstable, which may cause inconvenience to a user.

### DISCLOSURE

### Technical Problem

Accordingly, in the related field, in relation to a direct water purifier for providing purified water, cold water, and hot water in a direct manner, a measure for preventing pressure in a flow path from increasing when an instantaneous water heater is driven has been necessary.

### Technical Solution

To address the problem, an example embodiment of the present invention provides a direct water purifier.

The direct water purifier includes a first filter for filtering water flowing in through a first flow path; a second filter receiving and filtering water filtered by the first filter through a second flow path; a first valve provided on the second flow path and controlling a flow of water; a pump provided on the second flow path and supplying water having a predetermined pressure or higher to the second filter; a third filter receiving and filtering water filtered by the second filter through a third flow path; a second valve provided on the third flow path to decrease pressure in the flow path; a third valve provided on a rear end of the second valve on the third flow path and preventing water from flowing back; and a heating unit receiving water filtered by the third filter and heating the water to a predetermined temperature.

Also, the means for solving the above problem does not list all features of the present invention. Various features of the present invention and an advantage and an effect thereof will be understood in greater detail with reference to the following specific embodiments.

### Advantageous Effects

According to an example embodiment of the present invention, in a direct water purifier for providing purified water, cold water, and hot water in a direct manner, an increase of pressure in a flow path may be prevented when an instantaneous water heater is driven.

### DESCRIPTION OF DRAWINGS

FIG. 1 is a diagram illustrating a direct water purifier according to an example embodiment of the present invention; and

FIG. 2 is a diagram illustrating a direct water purifier according to another example embodiment of the present invention.

### BEST MODE FOR INVENTION

In the description below, preferable embodiments will be described in detail for a person skilled in the art to which the present invention belongs to may easily implement the present invention. However, in describing a preferable embodiment of the present invention in detail, if it is determined that a detailed description of a relevant known function or configuration may unnecessarily obscure the subject matter of the present invention, the detailed description thereof will not be provided. Also, the same reference numerals will be used for portions having similar functions and applications throughout the drawings.

Further, in the specification, when it is said that one part is “connected” to another part, the configuration may include the case in which the parts are “directly connected” and may also include “indirectly connected” with another element interposed therebetween. Also, the notion “including an element” may indicate that another element may be further included without excluding another element, unless otherwise indicated.

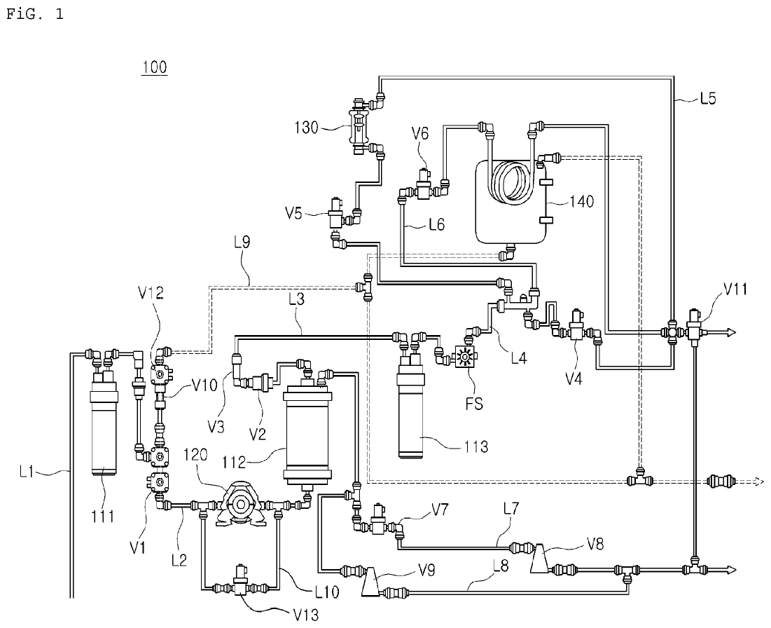

FIG. 1 is a diagram illustrating a direct water purifier according to an example embodiment of the present invention.

Referring to FIG. 1, a direct water purifier 100 according to an example embodiment of the present invention may include one or more filters 111, 112, and 113, a pump 120, a heating unit 130, a cooling unit 140, a flow path L1 to L10 connecting the above-mentioned elements, valves V1 to V13 provided on the flow path and controlling a flow of water, and a flow rate sensor FS.

Raw water supplied through the first flow path L1 may be filtered by the first filter 111. For example, the first filter 111 may be a pretreatment filter for primarily filtering raw water.

Water filtered by the first filter 111 may flow into the second flow path L2 through the first valve V1. For example, the first valve V1 may be implemented as a diaphragm valve such that water filtered by the first filter 111 may flow into the second flow path L2.

Water flowing through the second flow path L2 may be supplied to the second filter 112 and may be filtered. For example, the second filter 112 may be a reverse osmosis filter which may filter water by a reverse osmosis (RO) method.

Also, a pump 120 may be provided on the second flow path L2 and may supply water of a predetermined pressure or higher to the second filter 112. Accordingly, water filtration according to the reverse osmosis method may be smoothly performed in the second filter 112.

Also, a tenth flow path L10 which may connect a front end and a rear end of the pump 120 for bypassing, and a thirteenth valve V13 may be provided on the tenth flow path L10. Here, the tenth flow path L10 and the thirteenth valve V13 may be to bypass the front and rear ends of the pump 120 and may be referred to as a bypass flow path and a bypass valve, respectively. The thirteenth valve V13 may open the tenth flow path L10 while the heating unit 130, described later, operates. Accordingly, an excessive increase in pressure of the pump 120 may be prevented when the heating unit 130 operates.

The purified water filtered by the second filter 112 may be supplied to the third filter 113 through the third flow path L3 and may be filtered. For example, the third filter 113 may be a post-treatment filter for removing gas, odor, residual chlorine, and the like.

A second valve V2 for decreasing pressure in the flow path and a third valve V3 for preventing water from flowing back may be provided on the third flow path L3. By providing the second valve V2 for decreasing pressure in the flow path and the third valve V3 for preventing water from flowing back on the rear end of the second filter 112, an excessive increase of pressure in the flow path may be prevented even when a load is generated by operating the heating unit 130.

Meanwhile, concentrated water discharged from the second filter 112 may be discharged to a drain through the seventh flow path L7, or may be provided as water for domestic use through the eighth flow path L8.

A seventh valve V7 and an eighth valve V8 for performing a flushing operation may be provided on the seventh flow path L7, and a ninth valve V9 may be provided on the eighth flow path L8. Here, the seventh flow path L7 and the seventh valve V7 may be for performing a flushing operation, and may be referred to as a flushing flow path and a flushing valve, respectively. Also, the seventh valve V7 may be open to prevent an excessive increase of pressure of the front end of the second filter 112 or the rear end of the pump 120 when the extraction amount of purified water filtered through the second filter 112 is limited when the heating unit 130, described later, operates. However, when the second filter 112 is completely open, pressure may not be formed in the second filter 112 such that the second filter 112 may lose a water purification function. Therefore, to address the problem of completely opening the second filter 112, the eighth valve V8 and the ninth valve V9, each formed of a resistor, may be installed on the rear end of the seventh valve V7 and the eighth flow path L8 on the seventh flow path L7, respectively, thereby forming driving pressure required for the second filter 112.

Also, the seventh valve V7 may open the seventh flow path L7 while the heating unit 130, described later, operates. Accordingly, an excessive increase in pressure of the pump 120 may be prevented when the heating unit 130 operates.

The purified water filtered by the third filter 113 may be supplied to the user through the fourth flow path L4, may be heated while passing through the fifth flow path L5 branched from the fourth flow path L4, or may be cooled by passing through the sixth flow path L6 branched from the fourth flow path L4 and may be supplied to a user.

The flow rate sensor FS may be provided on the fourth flow path L4 and may sense a flow rate of purified water flowing through the fourth flow path L4. Also, a fourth valve V4 may be provided on the fourth flow path L4 and may control the supply of purified water through the fourth flow path L4.

A fifth valve V5 and the heating unit 130 may be provided on the fifth flow path L5. Here, the heating unit 130 may be an instantaneous water heater which may instantaneously heat the received purified water to a predetermined temperature. The fifth valve V5 may be provided on the front end of the heating unit 130 and may control the supply of hot water through the fifth flow path L5. For example, the fifth valve V5 may be implemented as a stepping motor and may adjust the flow rate of purified water supplied to the heating unit 130, thereby heating the purified water supplied to the heating unit 130 to hot water of a predetermined temperature.

A sixth valve V6 and a cooling unit 140 may be provided on the sixth flow path L6. Here, the cooling unit 140 may provide cold water by cooling purified water received in an ice-axial manner. For example, the cooling unit 140 may include an ice storage tank and a cooling coil, and non-drinking water in the ice storage tank may be cooled by the cooling coil, and the purified water flowing in by heat exchange may be instantly cooled. The sixth valve V6 may be provided on the front end of the cooling unit 140 and may control the supply of cold water through the sixth flow path L6.

Also, an eleventh valve V11 may be provided in an outlet means at which the fourth flow path L4, the fifth flow path L5, and the sixth flow path L6 are combined. For example, the eleventh valve V11 may be implemented as a two-way valve such that water discharged through the fourth flow path L4, the fifth flow path L5, or the sixth flow path L6 may be supplied to a user, or may be discharged to a drain.

Meanwhile, the water filtered by the first filter 111 may flow to the ninth flow path L9 and may be supplied to the ice storage tank provided in the cooling unit 140, or may be discharged externally. A tenth valve V10 and a twelfth valve V12 may be provided on the ninth flow path L9 branched from the rear end of the first filter 111. For example, the tenth valve V10 may be implemented as a check valve for preventing water from flowing back, and the twelfth valve V12 may be implemented as a diaphragm valve.

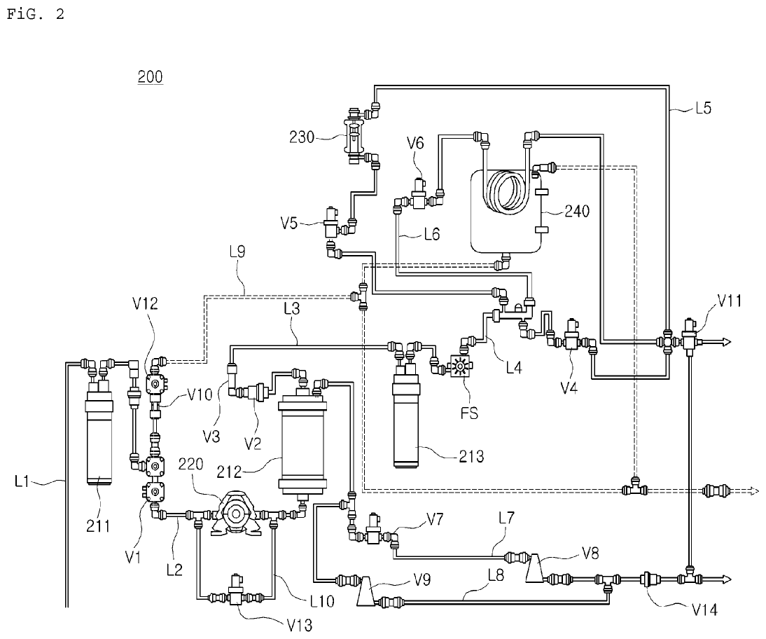

FIG. 2 is a diagram illustrating a direct water purifier according to another example embodiment of the present invention.

Referring to FIG. 2, a direct water purifier 200 according to another example embodiment of the present invention may include one or more filters 211, 212, and 213, a pump 220, a heating unit 230, a cooling unit 240, flow paths L1 to L10 connecting the above-mentioned elements, valves V1 to V14 provided on the flow path and controlling a flow of water, and a flow rate sensor FS.

The direct water purifier 200 illustrated in FIG. 2 may be different from the direct water purifier 100 in that the direct water purifier 200 may further include a fourteenth valve V14 on a drainage end at which the seventh flow path L7 and the eighth flow path L8 are combined, and the other elements may be the same as those of the direct water purifier 100.

Overlapping descriptions of the same elements will not be provided.

Here, the fourteenth valve V14 may be a pressure reducing valve provided in a drainage line of the second filter 212 and may prevent excessive flow pressure which may be cause by the lengthened drainage line.

When a water pipe is configured as illustrated in FIG. 1, flow pressure formed in the seventh flow path L7 may affect the second valve V2, and in some cases, the second valve V2 may be blocked. Therefore, the above-described issue may be addressed by adding the fourteenth valve V14.

While the example embodiments have been illustrated and described above, it will be apparent to those skilled in the art that modifications and variations could be made without departing from the scope of the present invention as defined by the appended claims.

1-3. (canceled)

4. A direct water purifier, comprising:
a pretreatment filter filtering water flowing in through a first flow path;
a reverse osmosis filter receiving and filtering water filtered by the pretreatment filter through a second flow path;
a flushing flow path connected to the reverse osmosis filter and discharging concentrated water;
a flushing valve provided on the flushing flow path;
a pump provided on the second flow path and supplying water having a water pressure equal to or higher than a predetermined water pressure to the reverse osmosis filter; and
a heating unit receiving water passing through the reverse osmosis filter and heating the water through an instantaneous water heater,
wherein the flushing valve opens the flushing flow path while the heating unit operates.

5. The direct water purifier of claim 4, further comprising:
a bypass flow path connecting a front end and a rear end of the pump for bypassing; and
a bypass valve provided on the bypass flow path,
wherein the bypass valve opens the bypass flow path while the heating unit operates.

6. The direct water purifier of claim 4, further comprising:
a pressure reducing valve provided on the third flow path connected to the reverse osmosis filter; and
a backflow prevention valve provided on the third flow path.

7. The direct water purifier of claim 6, further comprising:
a post-treatment filter receiving and filtering water filtered by the reverse osmosis filter through the third flow path,
wherein the heating unit receives water passing through the post-treatment filter.

8. The direct water purifier of claim 4, wherein the direct water purifier does not include a storage tank.

9. A direct water purifier, comprising:
a pretreatment filter filtering water flowing in through a first flow path;
a reverse osmosis filter receiving and filtering water filtered by the pretreatment filter through a second flow path;
a flushing flow path connected to the reverse osmosis filter and discharging concentrated water;
a flushing valve provided on the flushing flow path;
a pump provided on the second flow path and supplying water having a water pressure equal to or higher than a predetermined water pressure to the reverse osmosis filter;
a bypass flow path connecting a front end and a rear end of the pump for bypassing;
a bypass valve provided on the bypass flow path; and
a heating unit receiving water passing through the reverse osmosis filter and heating the water through an instantaneous water heater,
wherein the bypass valve opens the bypass flow path while the heating unit operates.

10. The direct water purifier of claim 9, further comprising:
a pressure reducing valve provided on the third flow path connected to the reverse osmosis filter; and
a backflow prevention valve provided on the third flow path.

11. The direct water purifier of claim 10, further comprising:
a post-treatment filter receiving and filtering water filtered by the reverse osmosis filter through the third flow path,
wherein the heating unit receives water passing through the post-treatment filter.

12. The direct water purifier of claim 9, wherein the direct water purifier does not include a storage tank.
